(19) United States
(12) Patent Application Publication
(10) Pub. No.: US 2025/0084983 A1
(43) Pub. Date: Mar. 13, 2025

(54) LAMP CAPABLE OF TRANSLATIONAL ADJUSTMENT OF LIGHT-EMITTING ANGLE AND IMPLEMENTATION METHOD THEREOF

(71) Applicant: Hengdian Group Tospo Lighting Co., Ltd., Jinhua (CN)

(72) Inventors: Meiling JIN, Jinhua (CN); Jiangen WEI, Jinhua (CN); Zhongyuan WANG, Jinhua (CN); Huannan WU, Jinhua (CN)

(73) Assignee: Hengdian Group Tospo Lighting Co., Ltd., Jinhua (CN)

(21) Appl. No.: 18/882,506

(22) Filed: Sep. 11, 2024

(30) Foreign Application Priority Data
Sep. 11, 2023 (CN) 202311174012.1

(51) Int. Cl. F21V 14/06; F21V 5/00; F21V 17/02; F21V 31/00; F21Y 105/16; F21Y 115/10

(52) U.S. Cl. CPC F21V 14/06; F21V 5/007; F21V 17/02; F21V 31/005; F21Y 2105/16; F21Y 2115/10

(57) ABSTRACT

A lamp capable of translational adjustment of a light-emitting angle is disclosed, including a lamp body, where a light source plate is installed inside the lamp body, and a translatable lens is provided above the light source plate; several rows of dimming lenses with different light-emitting angles are provided on the lens along a translation direction alternately; a surface cover located above the lens is connected to the lamp body, and adjustment knobs configured to adjust a position of the lens are installed on two sides of the lamp body. An implementation method of the lamp capable of translational adjustment of a light-emitting angle is also disclosed. Several rows of dimming lenses with three different light-emitting angles are provided on the lens along the translation direction, and the lens may be moved by rotating the adjustment knobs so that the dimming lenses with corresponding light-emitting angles correspond to LED lamp beads on the light source plate, thereby achieving the adjustment of the light-emitting angle without the waste of redundant lenses, and thus reducing the cost of adjusting the light-emitting angle.

### CROSS-REFERENCE TO RELATED APPLICATION

This application claims priority to Chinese patent application No. 202311174012.1, filed Sep. 11, 2023, the entirety of which are herein incorporated by reference.

### FIELD OF THE INVENTION

The present disclosure belongs to the technical field of lamps, and particularly relates to a lamp capable of translational adjustment of a light-emitting angle and an implementation method thereof.

### BACKGROUND OF THE INVENTION

Currently, outdoor products for export are undergoing an inventory reduction innovation. The large number of models and specifications has led to increasing inventory pressure for intermediaries and buyers, making it difficult to allocate products and resulting in large turnover maintenance and storage costs. In this context, reducing the inventory model has become the trend of product development in the past two years. For a product, adjusting different color temperatures, adjusting different powers, and replacing lenses are common methods at this stage.

On the basis of realizing the model reduction, reducing the cost will be the focus of the product in the future. The increased unit price of products due to stacking functions requires breakthrough solutions to minimize.

In the past, in the lens part, various lenses with different light-emitting angles were incorporated into a single product, and lenses were assembled based on actual usage requirements, while the remaining lenses of other angles were discarded, leading to waste.

### SUMMARY OF THE INVENTION

It is an object of the present disclosure to provide a lamp capable of translational adjustment of a light-emitting angle so as to solve the problems set forth in the above background. The present disclosure provides a lamp capable of translational adjustment of a light-emitting angle, with the feature of facilitating the adjustment of a light-emitting angle.

Another object of the present disclosure is to provide an implementation method of the lamp capable of translational adjustment of a light-emitting angle.

In order to achieve the above-mentioned object, the present disclosure provides the following technical solution. A lamp capable of translational adjustment of a light-emitting angle is provided, including a lamp body, where a light source plate is installed inside the lamp body, and a translatable lens is provided above the light source plate; several rows of dimming lenses with different light-emitting angles are provided on the lens along a translation direction alternately; a surface cover located above the lens is connected to the lamp body, and adjustment knobs configured to adjust a position of the lens are installed on two sides of the lamp body.

Further, in order to install the adjustment knobs, two sides of the lamp body are arranged with installation grooves configured for insertion of the adjustment knobs. The adjustment knob is installed on the lamp body through an installation sleeve.

Further, in order to translate the lens, two sides of the lens are provided with symmetrical racks, and a circumference of the adjustment knob is provided with a ring gear engaging with the rack.

Further, in order to increase the friction force between the adjustment knob and a finger and make the rotation of the adjustment knob more convenient, the circumference of the adjustment knob is also provided with several protrusions.

Further, in order to not only ensure the waterproofing of the whole lamp, but also generate a friction force between the lens and the lamp body so that the lens does not move in a natural state, a periphery of a back surface of the lens is arranged with a sealing groove, and a sealing ring is connected inside the sealing groove.

Further, in order to facilitate a quick determination of the adjusted light-emitting angle, indication marks are provided above the surface cover, and corresponding indication arrows are provided on the lens.

Further, in the present disclosure, an implementation method of the lamp capable of translational adjustment of a light-emitting angle is provided, including the steps of:
(1) connecting a surface cover to a lamp body through screws to press a lens on a surface of the lamp body;
(2) under the action of a sealing ring, not only ensuring the waterproofing of the whole lamp, but also generating a friction force between the lens and the lamp body so that the lens does not move in a natural state; and
(3) when it is necessary to adjust a light-emitting angle, moving the lens by rotating adjustment knobs so that corresponding dimming lenses correspond to the LED lamp beads on a light source plate, thereby adjusting the light-emitting angle.

Compared with the related art, the beneficial effects of the present disclosure are as follows.
1. In the present disclosure, several rows of dimming lenses with three different light-emitting angles are provided on the lens along the translation direction, and the lens may be moved by rotating the adjustment knobs so that the dimming lenses with corresponding light-emitting angles correspond to LED lamp beads on the light source plate, thereby achieving the adjustment of the light-emitting angle without the waste of redundant lenses, and thus reducing the cost of adjusting the light-emitting angle.
2. In the present disclosure, two sides of the lens are provided with symmetrical racks, and the circumference of the adjustment knob is provided with the ring gear engaging with the rack. The lens may be translated by rotating the adjustment knobs so that the adjustment of the lens is more convenient.
3. In the present disclosure, the circumference of the adjustment knob is also provided with several protrusions, thereby increasing the friction force between the adjustment knob and the finger and making the rotation of the adjustment knob more convenient.
4. In the present disclosure, the periphery of the back surface of the lens is arranged with the sealing groove, and the sealing ring is connected inside the sealing groove, thereby under the action of the sealing ring, not only ensuring the waterproofing of the whole lamp, but also generating a friction force between the lens and the lamp body so that the lens does not move in the natural state.
5. In the present disclosure, the indication marks are provided above the surface cover, and the corresponding indication arrows are provided on the lens, thereby facilitating a quick determination of the adjusted light-emitting angle.

### BRIEF DESCRIPTION OF THE DRAWINGS

FIG. 1 is an exploded structural schematic diagram of the present disclosure;

FIG. 2 is a schematic structural diagram of an adjustment knob of the present disclosure;

FIG. 3 is a schematic structural diagram showing the connection of an adjustment knob and a lens of the present disclosure;

FIG. 4 is a schematic structural diagram of a back surface of a lens of the present disclosure; and

FIG. 5 is a schematic structural diagram of a surface cover of the present disclosure.

In the drawings: 1—lamp body; 2—sealing ring; 3—surface cover; 31—indication mark; 4—lens; 41—dimming lens; 42—indication arrow; 43—rack; 44—sealing groove; 5—light source plate; 6—adjustment knob; 61—protrusion; 62—ring gear; 7—installation sleeve; and 8—installation groove.

### DETAILED DESCRIPTION OF THE EMBODIMENTS

The technical solutions in the embodiments of the present disclosure will be clearly and completely described below in conjunction with the accompanying drawings in the embodiments of the present disclosure. Obviously, the described embodiments are only some embodiments of the present disclosure, not all embodiments. Based on the embodiments of the present disclosure, all other embodiments obtained by a person skilled in the art without inventive effort fall within the scope of the present disclosure.

### Embodiment 1

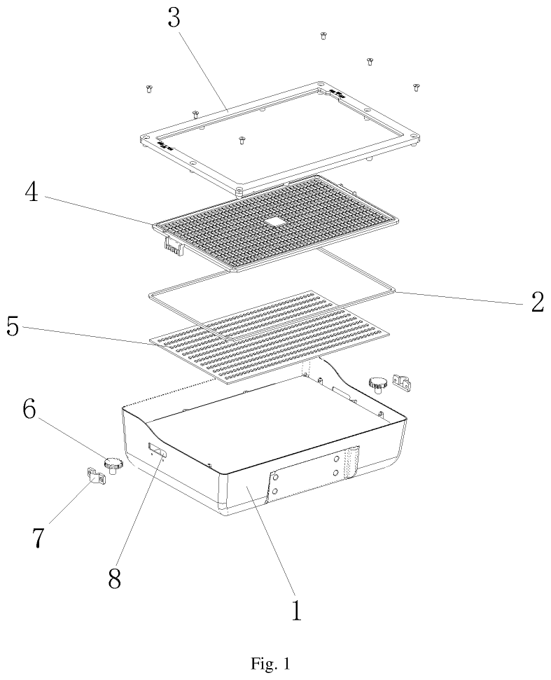

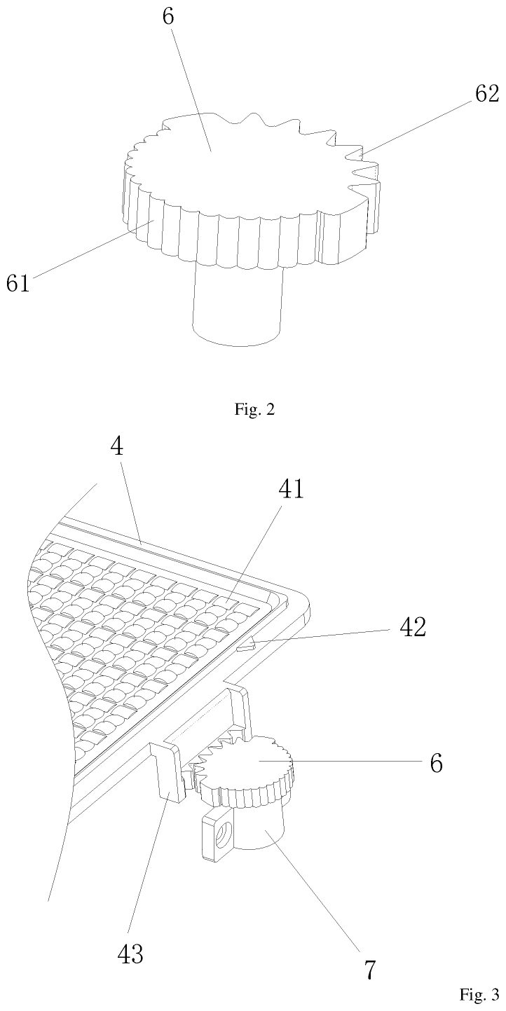

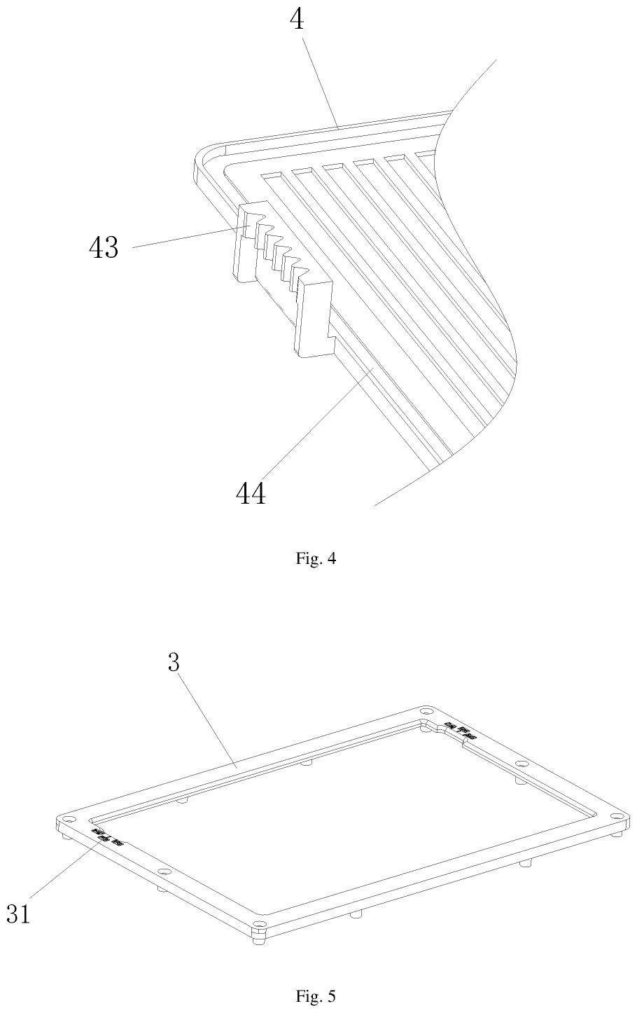

Referring to FIGS. 1-5, the present disclosure provides the following technical solution. A lamp capable of translational adjustment of a light-emitting angle is provided, including a lamp body 1. A light source plate 5 is installed inside the lamp body 1, and a translatable lens 4 is provided above the light source plate 5. Several rows of dimming lenses 41 with different light-emitting angles are provided on the lens 4 along a translation direction alternately. A surface cover 3 located above the lens 4 is connected to the lamp body 1, and adjustment knobs 6 configured to adjust a position of the lens 4 are installed on two sides of the lamp body 1.

According to the above-mentioned technical solution, in the present disclosure, several rows of dimming lenses 41 with three different light-emitting angles are provided on the lens 4 along the translation direction, and the lens 4 may be moved by rotating the adjustment knobs 6 so that the dimming lenses 41 with corresponding light-emitting angles correspond to LED lamp beads on the light source plate 5, thereby achieving the adjustment of the light-emitting angle without the waste of redundant lenses, and thus reducing the cost of adjusting the light-emitting angle.

Specifically, two sides of the lamp body 1 are arranged with installation grooves 8 configured for insertion of the adjustment knobs 6. The adjustment knob 6 is installed on the lamp body 1 through an installation sleeve 7.

According to the above-mentioned technical solution, the adjustment knob 6 is installed.

Specifically, two sides of the lens 4 are provided with symmetrical racks 43, and a circumference of the adjustment knob 6 is provided with a ring gear 62 engaging with the rack

43.

According to the above-mentioned technical solution, the lens 4 may be translated by rotating the adjustment knobs 6.

Specifically, the circumference of the adjustment knob 6 is also provided with several protrusions 61.

According to the above-mentioned technical solution, the friction force between the adjustment knob 6 and the finger is increased so that the rotation of the adjustment knob 6 is more convenient.

### Embodiment 2

This embodiment differs from embodiment 1 in that: specifically, a periphery of a back surface of the lens 4 is arranged with a sealing groove 44, and a sealing ring 2 is connected inside the sealing groove 44.

According to the above-mentioned technical solution, under the action of a sealing ring 2, not only the waterproofing of the whole lamp is ensured, but also a friction force between the lens 4 and the lamp body 1 is generated so that the lens 4 does not move in a natural state.

### Embodiment 3

This embodiment differs from embodiment 1 in that: specifically, indication marks 31 are provided above the surface cover 3, and corresponding indication arrows 42 are provided on the lens 4.

According to the above-mentioned technical solution, it is convenient to quickly determine the adjusted light-emitting angle.

### Embodiment 4

Further, the implementation method of the lamp capable of translational adjustment of a light-emitting angle according to the present disclosure includes the steps of:
(1) connecting a surface cover 3 to a lamp body 1 through screws to press a lens 4 on a surface of the lamp body 1;
(2) under the action of a sealing ring 2, not only ensuring the waterproofing of the whole lamp, but also generating a friction force between the lens 4 and the lamp body 1 so that the lens 4 does not move in a natural state; and
(3) when it is necessary to adjust a light-emitting angle, moving the lens 4 by rotating adjustment knobs 6 so that corresponding dimming lenses 41 correspond to the LED lamp beads on a light source plate 5, thereby adjusting the light-emitting angle.

In summary, in the present disclosure, several rows of dimming lenses 41 with three different light-emitting angles are provided on the lens 4 along the translation direction, and the lens 4 may be moved by rotating the adjustment knobs 6 so that the dimming lenses 41 with corresponding light-emitting angles correspond to LED lamp beads on the light source plate 5, thereby achieving the adjustment of the light-emitting angle without the waste of redundant lenses, and thus reducing the cost of adjusting the light-emitting angle. Two sides of the lens 4 are provided with symmetrical racks 43, and the circumference of the adjustment knob 6 is provided with the ring gear 62 engaging with the rack 43. The lens 4 may be translated by rotating the adjustment knobs 6 so that the adjustment of the lens 4 is more convenient. The circumference of the adjustment knob 6 is also provided with several protrusions 61, thereby increasing the friction force between the adjustment knob 6 and the finger and making the rotation of the adjustment knob 6 more convenient. The periphery of the back surface of the lens 4 is arranged with the sealing groove 44, and the sealing ring 2 is connected inside the sealing groove 44, thereby under the action of the sealing ring 2, not only ensuring the waterproofing of the whole lamp, but also generating a friction force between the lens 4 and the lamp body 1 so that the lens 4 does not move in the natural state. The indication marks 31 are provided above the surface cover 3, and the corresponding indication arrows 42 are provided on the lens 4, thereby facilitating a quick determination of the adjusted light-emitting angle.

While embodiments of the present disclosure have been shown and described, it will be understood by a person skilled in the art that various changes, modifications, substitutions, and alterations may be made herein without departing from the principles and spirit of the present disclosure, and the scope of the present disclosure is defined by the appended claims and their equivalents.

1. A lamp capable of translational adjustment of a light-emitting angle, comprising a lamp body, wherein a light source plate is installed inside the lamp body, and a translatable lens is provided above the light source plate; several rows of dimming lenses with different light-emitting angles are provided on the lens along a translation direction alternately; a surface cover located above the lens is connected to the lamp body, and adjustment knobs configured to adjust a position of the lens are installed on two sides of the lamp body.

2. The lamp capable of translational adjustment of a light-emitting angle according to claim 1, wherein two sides of the lamp body are arranged with installation grooves configured for insertion of the adjustment knobs.

3. The lamp capable of translational adjustment of a light-emitting angle according to claim 1, wherein the adjustment knob is installed on the lamp body through an installation sleeve.

4. The lamp capable of translational adjustment of a light-emitting angle according to claim 1, wherein two sides of the lens are provided with symmetrical racks, and a circumference of the adjustment knob is provided with a ring gear engaging with the rack.

5. The lamp capable of translational adjustment of a light-emitting angle according to claim 4, wherein the circumference of the adjustment knob is also provided with several protrusions.

6. The lamp capable of translational adjustment of a light-emitting angle according to claim 1, wherein a periphery of a back surface of the lens is arranged with a sealing groove, and a sealing ring is connected inside the sealing groove.

7. The lamp capable of translational adjustment of a light-emitting angle according to claim 1, wherein indication marks are provided above the surface cover, and corresponding indication arrows are provided on the lens.

8. An implementation method of the lamp capable of translational adjustment of a light-emitting angle according to claim 1, comprising the steps of:
(1) connecting a surface cover to a lamp body through screws to press a lens on a surface of the lamp body;
(2) under the action of a sealing ring, not only ensuring the waterproofing of the whole lamp, but also generating a friction force between the lens and the lamp body so that the lens does not move in a natural state; and
(3) when it is necessary to adjust a light-emitting angle, moving the lens by rotating adjustment knobs so that corresponding dimming lenses correspond to the LED lamp beads on a light source plate, thereby adjusting the light-emitting angle.
